(19) United States
(12) Patent Application Publication
(10) Pub. No.: US 2026/0249441 A1
(43) Pub. Date: Aug. 27, 2026

(54) Hand-Held Processing Device

(71) Applicant: Andreas Stihl AG & Co. KG, Waiblingen (DE)

(72) Inventors: Georg Heinzelmann, Winnenden (DE); Carel Karrar, Rechberghausen (DE); Timo Henke, Kernen im Remstal (DE)

(21) Appl. No.: 19/547,800

(22) Filed: Feb. 24, 2026

(30) Foreign Application Priority Data
Feb. 26, 2025 (DE) 10 2025 107 303.1
Feb. 26, 2025 (DE) 10 2025 107 305.8
Feb. 26, 2025 (DE) 10 2025 107 307.4

(51) Int. Cl. B25F 5/02; B27B 17/02; B27B 17/08; B27B 17/12; H01M 10/48; H01M 50/247

(52) U.S. Cl. CPC B25F 5/02; H01M 10/488; H01M 50/247; B27B 17/02; B27B 17/083; B27B 17/12; H01M 2220/30

(57) ABSTRACT

A hand-held processing device has: a receiving apparatus for replaceably receiving an electrical battery pack in a receiving direction, wherein the receiving apparatus has a receiving space for the battery pack, and a front receiving apparatus side relative to a longitudinal direction of extent of the processing device, wherein the front receiving apparatus side partially defines the receiving space, and at least two viewing openings which oppose the front receiving apparatus side and which in each case open the receiving space outwardly counter to the longitudinal direction of extent. The at least two viewing openings are arranged relative to one another such that they are aligned with one another in a transparent manner-when the battery pack is not received-when viewed in a width direction of the processing device at right-angles both to the receiving direction and to the longitudinal direction of extent.

### CROSS REFERENCE TO RELATED APPLICATIONS

This application claims priorities under 35 U.S.C. § 119 from German Patent Application Nos. 102025107303.1, filed Feb. 26, 2025, 102025107307.4, filed Feb. 26, 2025, and 102025107305.8, filed Feb. 26, 2025, the entire disclosures of which are herein expressly incorporated by reference.

### BACKGROUND AND SUMMARY

The invention relates to a hand-held processing device, in particular in each case comprising a plurality of aspects of the invention.

It is an object of the present invention to provide a hand-held processing device which has specific, in particular improved, properties. In particular, a battery pack receiving apparatus of the processing device is intended to be modified from the perspective of a lightweight construction and/or regarding its functionality when the battery pack is not received.

This object is achieved by the subject matter of the independent claims. Preferred embodiments form the subject matter of the dependent claims. The wording of all of the claims expressly refers to the contents of the present description.

Aspects of the invention mentioned above and/or below can be implemented individually or jointly. In this regard, a hand-held processing device according to one of the aspects of the invention can optionally also be further developed according to a further aspect of the invention. In particular, the aspects of the invention can be implemented in the same hand-held processing device.

Embodiments of the invention-provided they are not expressly specified in a definitive manner or otherwise exclusively-can be based in principle on any of the aspects of the invention individually or on a combination of some or all of the aspects of the invention. In particular, the same applies relative to expedient information.

A hand-held processing device according to a first aspect of the invention has a receiving apparatus for replaceably receiving an electrical battery pack. The receiving apparatus is configured to receive the battery pack in a receiving direction. The received battery pack can be removed from the receiving apparatus counter to the receiving direction. The receiving apparatus has a receiving space for the battery pack. The processing device has a longitudinal direction of extent. In particular, the processing device is longitudinally extended in the longitudinal direction of extent. The processing device has a front receiving apparatus side relative to the longitudinal direction of extent. In particular, the front receiving apparatus side is a side of the receiving apparatus arranged at the front relative to the longitudinal direction of extent. “Front” can mean “facing a tool apparatus”. The front receiving apparatus side at least partially defines the receiving space. In particular, the receiving apparatus side is an inner side region of the receiving apparatus. The processing device has at least, in particular exactly, two viewing openings which oppose the front receiving apparatus side and which in each case open the receiving space outwardly counter to the longitudinal direction of extent. In particular, the viewing openings oppose the front receiving apparatus side transversely to the receiving direction and/or in the longitudinal direction of extent. The processing device has a width direction which runs at right-angles both to the receiving direction and to the longitudinal direction of extent. In particular, the processing device is transversely extended in the width direction. The two viewing openings are arranged relative to one another such that they are aligned with one another in a transparent manner-when the battery pack is not received-when viewed in the width direction. The two viewing openings, when viewed in the width direction, can completely or partially overlap one another. In particular, the two viewing openings are aligned with one another in a transparent manner in a side view of the processing device, in particular in a viewing direction parallel to a drive axis of a drive apparatus of the processing device. The drive axis can run parallel to the width direction.

In particular, the viewing openings are arranged in each case partially on a rear receiving apparatus side of the processing device, wherein the rear receiving apparatus side opposes the front receiving apparatus side. The front receiving apparatus side can be exposed facing to the rear when the battery pack is not received. When the battery pack is received, the front receiving apparatus side can adjoin the received battery pack in the longitudinal direction of extent, in particular directly. The rear receiving apparatus side can be exposed facing to the front when the battery pack is not received. When the battery pack is received, the rear receiving apparatus side can adjoin the received battery pack counter to the longitudinal direction of extent, in particular directly. In other words: the received battery pack can be arranged in the longitudinal direction of extent, in particular directly, between the front receiving apparatus side and the rear receiving apparatus side. The front receiving apparatus side and the rear receiving apparatus side can flank the received battery pack.

The viewing openings can assist in reducing the mass of the receiving apparatus and thus the entire processing device. Alternatively or additionally, the viewing openings can promote a cooling of the received battery pack with ambient air. Further alternatively or additionally, the viewing openings can permit a view of a label which is present on the received battery pack. Further alternatively or additionally, the viewing openings-when the battery pack is not received-permit a view of the front receiving apparatus side, in particular in order to read an apparatus and/or marking which is present there.

Expediently, the term “receiving apparatus” can be used synonymously with the term “battery pack receiving apparatus”.

Expediently, the receiving space can be configured in a complementary manner to at least one plug-in portion of the battery pack.

Expediently, the front receiving apparatus side can correspond to a front guide surface portion of the receiving apparatus or can run parallel to the front guide surface portion, wherein the front guide surface portion is configured for guiding the battery pack in the receiving direction.

Expediently, the longitudinal direction of extent faces toward a tool attachment apparatus of the processing device, wherein the tool apparatus for the processing device can be releasably mounted on the tool attachment apparatus. In particular, the tool attachment apparatus forms an end region of the processing device furthest to the front in the longitudinal direction of extent.

Expediently, the processing device has an electrical drive apparatus which is configured for providing drive power for the tool apparatus which can be mounted on the processing device, based on electrical energy taken from the received battery pack.

Expediently, the processing device is configured to be able to be operated by battery power.

In one embodiment of the invention, in particular on the basis of at least the first aspect of the invention, the at least two viewing openings in the width direction flank a web portion of the processing device which is continuous in the receiving direction. The web portion running continuously in the receiving direction can be arranged in the width direction, in particular directly, between the at least two viewing openings. In particular, the web portion at least partially forms a rear guide surface portion of the processing device relative to the longitudinal direction of extent for guiding the battery pack in the receiving direction. In particular, the web portion can counteract a positioning of an edge of the battery pack on an opening edge of the respective viewing opening when the battery pack is introduced in the receiving direction.

In a further embodiment of the invention, in particular on the basis of at least the first aspect of the invention, the web portion has, in particular, an integral and/or internal line channel of the processing device. The line channel is configured for guiding at least one electrical line of the processing device. In particular, the at least one line is guided through the line channel. The at least one electrical line guided through the line channel can connect an operating apparatus of the processing device to an electronic control apparatus of the processing device. In particular, two or more electrical lines can be guided in the receiving direction through the line channel in order to connect the operating apparatus to the electronic control apparatus in the receiving direction. The at least one electrical line can be longitudinally extended in this regard in the receiving direction between the operating apparatus and the control apparatus. The control apparatus can be configured for controlling a handle heater of the rear handle portion.

In a further embodiment of the invention, the web portion has a web width measured in the width direction. The receiving space has a receiving space width measured in the width direction, in particular on the inside. The, in particular maximum, receiving space width corresponds to 1.5 times to 6 times, in particular approximately 3 times, the, in particular minimum, web width.

In a further embodiment of the invention, in particular on the basis of at least the first aspect of the invention, the processing device has a placement apparatus. The placement apparatus defines a placement plane. The placement apparatus is configured for contact with a substrate for the processing device in the placement plane, in particular when the processing device is placed or deposited on the substrate. The receiving direction runs at an angle, in particular at right-angles or at an acute angle, to the placement plane.

Expediently, the receiving direction can run at an acute angle to the placement plane such that it faces obliquely to the rear downwardly counter to the longitudinal direction of extent and/or it encloses with the placement plane an acute angle which widens obliquely to the rear downwardly relative to the longitudinal direction of extent. “Rear” can mean “facing away from the tool attachment apparatus”. The acute angle can be 60° to 85°, in particular approximately 80°.

Expediently, the placement apparatus can have at least one support foot and/or at least one support rib.

In a further embodiment of the invention, in particular on the basis of at least the first aspect of the invention, an electronic control apparatus of the processing device adjoins the receiving apparatus in the region of an end of the receiving space facing the placement plane counter to the longitudinal direction of extent.

Expediently, it is possible to provide a cavity, which is concealed in the interior of an externally visible depression of a housing of the processing device, for receiving the electronic control apparatus.

Expediently, the processing device can have two electronic control apparatuses, wherein only one of these electronic control apparatuses adjoins the receiving apparatus in the region of the end of the receiving space facing the placement plane counter to the longitudinal direction of extent. In particular, the control apparatus which adjoins the receiving apparatus in the region of the end of the receiving space facing the placement plane counter to the longitudinal direction of extent is the control apparatus for controlling the handle heater.

Expediently, the end of the receiving space can be an end of the receiving space facing away from the tool apparatus, the control apparatus for controlling the handle heater being connected in the region thereof.

In a further embodiment of the invention, in particular on the basis of at least the first aspect of the invention, the processing device has electrical connecting elements for electrically connecting the received battery pack. The connecting elements are arranged in the receiving direction between the viewing openings and the placement apparatus of the processing device. In particular, the electrical connecting elements face counter to the receiving direction. Alternatively or additionally, the receiving apparatus has a receiving opening for introducing the battery pack to be received and a through-opening which opposes the receiving opening in the receiving direction and which is provided, in particular, with a grille. The connecting elements can be present, in particular, in the region of an end of the receiving apparatus comprising the through-opening.

In a further embodiment of the invention, in particular on the basis of at least the first aspect of the invention, the viewing openings are configured mirror-symmetrically relative to a longitudinal central plane of the processing device.

Expediently, the processing device has a rear handle portion which defines a rear end of the processing device relative to the longitudinal direction of extent of the processing device, in particular facing away from the tool attachment apparatus. The longitudinal central plane is defined, in particular, by the rear handle portion.

In a further embodiment of the invention, in particular on the basis of at least the first aspect of the invention, the viewing openings are in each case longitudinally extended in the receiving direction. The viewing openings can have in each case an opening length measured in the receiving direction and/or an opening width measured perpendicularly to the receiving direction. In particular, the opening length of one respective viewing opening is 10 mm to 120 mm, in particular 30 mm to 50 mm. Alternatively or additionally, the opening width of one respective viewing opening can be 10 mm to 50 mm.

Expediently, the opening length or the opening width can correspond in each case to the maximum free spacing of opposing edge portions of an opening edge of the relevant viewing opening in the receiving direction or perpendicular to the receiving direction. Alternatively or additionally, the opening width of the viewing openings can be measured perpendicularly to the longitudinal central plane.

In a further embodiment of the invention, in particular on the basis of at least the first aspect of the invention, the receiving space has a substantially prismatic, in particular cuboidal, shape. The shape of the receiving space has at least two edge regions which are longitudinally extended in the receiving direction, wherein the edge regions flank a rear guide surface portion of the processing device partially defining the receiving space in the width direction. The rear guide surface portion can thus be arranged in the width direction between the edge regions. The edge regions are, in particular, inner edge regions. Each of the viewing openings interrupts one of the edge regions. In particular, respectively one of the edge regions is longitudinally extended by 1.5 times to 15 times the opening length of the viewing openings. The interruption of the edge regions by the viewing openings can permit a particularly robust design of the processing device, in particular by targeted weakening of the structure of the housing of the processing device defining the receiving space.

In a further embodiment of the invention, in particular at least on the basis of the first aspect of the invention—in a side view of the processing device resulting from viewing in the width direction—a virtual straight line running at right-angles to the placement plane is at a tangent to the opening edges of the viewing openings relative to the longitudinal direction of extent of the processing device at the front. In other words: the imaginary straight line is at a tangent to one respective opening edge at a point on the relevant opening edge furthest to the front relative to the longitudinal direction of extent, thus in particular facing the tool apparatus. The straight line at a tangent to the opening edges at the front and at right-angles to the placement plane runs relative to the longitudinal direction of extent of the processing device either in front of the electrical connecting elements or through the electrical connecting elements.

A hand-held processing device according to a second aspect of the invention has a receiving apparatus, wherein the receiving apparatus is configured for replaceably receiving an electrical battery pack in a receiving direction. The received battery pack can be removed from the receiving apparatus counter to the receiving direction. The receiving apparatus has a receiving opening for introducing the battery pack to be received. The processing device has a lubricant tank which is configured for storing lubricant. In particular, a tool apparatus which can be mounted on the processing device can be lubricated by means of the lubricant. The processing device has a filling level display apparatus which is configured for displaying a filling level of stored lubricant. The filling level which can be displayed by means of the filling level display apparatus is, in particular, a filling level of lubricant in the lubricant tank. The filling level display apparatus is arranged such that the displayed filling level can be read from the outside by looking through the receiving opening for the battery pack-when the battery pack is not received. In other words: when viewed from the outside through the receiving opening the filling level display apparatus can be visually identified such that the filling level displayed by means of the filling level display apparatus can be read through the receiving opening for the battery pack. Thus an operator of the processing device can read the filling level of the lubricant tank, in particular the filling level display apparatus, by looking from the outside through the receiving opening onto the processing device.

Expediently, a lubricant tank internal volume available for storing lubricant can be dimensioned such that at least one battery pack which is fully charged with electrical energy, in particular more than one battery pack in succession, can be discharged for powering an electrical drive apparatus of the processing device before a complete lubricant tankful of lubricant is used up, wherein the drive apparatus is configured for providing electrical drive power for the tool apparatus on the basis of the electrical energy taken from the relevant battery pack. Based thereon it can be particularly advantageous, when changing the battery pack, to be able to read the filling level, in particular in order to be able to estimate whether refilling lubricant is required. Due to the visibility of the filling level display apparatus when the battery pack is removed, it is possible to be made aware of the need to refill lubricant, not too early but at the correct time.

Expediently, the filling level display apparatus is concealed, in particular is not readable, when the battery pack is received. In particular, the received battery pack conceals the filling level display apparatus so that the filling level display apparatus cannot be read through the receiving opening when the battery pack is received.

In one embodiment of the invention, in particular at least on the basis of the second aspect of the invention, the lubricant tank has at least one transparent tank wall portion. The at least one transparent tank wall portion forms the filling level display apparatus. In this regard, the at least one transparent tank wall portion can be arranged such that the displayed filling level can be read from the outside by looking through the receiving opening for the battery pack, when the battery pack is not received.

Expediently, a lubricant level present on the inside of the transparent tank wall portion can be shown exceptionally clearly, in particular so that the lubricant level shown can be detected visually on the outside of the transparent tank wall portion.

In a further embodiment of the invention, in particular at least on the basis of the second aspect of the invention, the filling level display apparatus at least partially forms a front receiving apparatus side of the processing device relative to a longitudinal direction of extent of the processing device. The front receiving apparatus side can be a front guide surface portion for guiding the battery pack in the receiving direction or can run parallel to this front guide surface portion. The front receiving apparatus side partially defines a receiving space of the receiving apparatus.

In a further embodiment of the invention, in particular at least on the basis of the second aspect of the invention, the processing device has a placement apparatus. The placement apparatus defines a placement plane and is configured for contact with a substrate for the processing device in the placement plane. The receiving direction runs at an angle, in particular at right-angles or at an acute angle, to the placement plane. Expediently, the receiving direction can run at an acute angle to the placement plane such that it faces obliquely to the rear downwardly counter to the longitudinal direction of extent and/or that it encloses with the placement plane an acute angle which widens obliquely to the rear downwardly relative to the longitudinal direction of extent. “Rear” can mean “facing away from the tool attachment apparatus”. The acute angle can be 60° to 85°, in particular approximately 80°.

In a further embodiment of the invention, in particular at least on the basis of the second aspect of the invention, the receiving opening and the placement apparatus of the processing device are arranged opposing one another in the receiving direction. Alternatively or additionally, the filling level display apparatus, in particular adapted to the viewing angle, is inclined relative to the placement plane defined by the placement apparatus. An inclination of the filling level display apparatus can correspond to an inclination of the receiving direction relative to the placement plane. An inclination of the receiving apparatus can correspond in some portions to a path of a wall portion of the lubricant tank and, in particular, the wall portion of the lubricant tank and the front wall portion can run in an inclined manner parallel to one another.

In a further embodiment of the invention, in particular at least on the basis of the second aspect of the invention, the filling level display apparatus has a marking as a reference indicator for the filling level which is visible from the outside by looking through the receiving opening when the battery pack is not received. The marking can be configured integrally on a transparent tank wall portion forming the filling level display apparatus.

In a further embodiment of the invention, in particular at least on the basis of the second aspect of the invention, the processing device has at least one viewing opening which opens outwardly the receiving space of the receiving apparatus, in particular transversely to the receiving direction. The filling level display apparatus is arranged such that the displayed filling level can be read from the outside by looking through the viewing opening when the battery pack is not received. In this manner, a further option for reading the filling level can be achieved.

In a further embodiment of the invention, in particular at least on the basis of the second aspect of the invention, the processing device has at least, in particular exactly, two such viewing openings. The viewing openings oppose the front receiving apparatus side relative to the longitudinal direction of extent of the processing device and open the receiving space outwardly, in each case counter to the longitudinal direction of extent. The viewing openings are arranged relative to one another such that they are aligned with one another in a transparent manner—when the battery pack is not received—when viewed in a width direction of the processing device at right-angles both to the receiving direction and to the longitudinal direction of extent. By providing at least two viewing openings, a number of reading options, in particular reading directions, can be increased.

In a further embodiment of the invention, in particular at least on the basis of the second aspect of the invention, the receiving apparatus has, in particular, a non-transparent wall portion. The wall portion of the receiving apparatus partially conceals the lubricant tank, in particular a transparent tank wall portion of the lubricant tank. The wall portion of the receiving apparatus can serve for an integrated cable guidance for guiding electrical cables toward the electrical connecting elements. Alternatively or additionally, the wall portion can mechanically reinforce a contact plate bearing the connecting elements.

Expediently, the filling level display apparatus, in particular the transparent tank wall portion, can be extended as far as a bottom region and/or as far as a flank side region of the processing device, so that further reading options can be produced in addition to the option of reading through the receiving opening and/or the at least one viewing opening.

In a further embodiment of the invention, in particular at least on the basis of the first aspect of the invention and/or the second aspect of the invention, the processing device is a chainsaw, in particular a motorized chainsaw, or an angle grinder.

A hand-held processing device according to a third aspect of the invention has a receiving apparatus. The receiving apparatus is configured for replaceably receiving an electrical battery pack in a receiving direction of the processing device. The “receiving apparatus” can be denoted synonymously as the “battery pack receiving apparatus”. In particular, an electrical connection of the battery pack to the processing device is associated with the receiving of the battery pack in the receiving direction. The receiving apparatus can have a battery compartment in which the battery pack to be received can be inserted in the receiving direction. The battery compartment can be longitudinally extended in the receiving direction, in particular in the manner of a hollow profile. The receiving apparatus of the processing device has a receiving opening. The receiving apparatus can be formed by a single component or by a plurality of components. The receiving opening is configured for introducing the battery pack to be received. The receiving apparatus also has a through-opening. The through-opening opposes the receiving opening, in particular in the receiving direction. The through-opening can be configured for expelling dirt. The processing device has a grille element. The grille element has at least three grille openings and is configured for providing the through-opening with a grille which is permeable to dirt. In particular, the through-opening is provided with a grille by means of the grille element such that partial regions of the through-opening defined by the grille openings are permeable to dirt and/or exposed. “Permeable to dirt” can mean, in particular, “permeable to liquid and/or solid particles”. In particular, the grille element is not configured from wood.

In particular, without an additional option for access by the hand of an operator, an improved ability to clean a battery pack receiving apparatus of the processing device is intended to be achieved by the third aspect of the invention.

The through-opening can provide an additional path for the passage of dirt relative to the receiving opening. The grille element, in particular the at least three grille openings, can bring about a reduction in an opening cross section which is permeable to dirt, relative to the entire opening cross section of the through-opening. The grille element, in particular the grille openings thereof, can permit dirt to be expelled in the receiving direction but counteract a penetration of larger foreign bodies and/or a human finger counter to the receiving direction or hinder, in particular prevent, such a penetration counter to the receiving direction.

Expediently, the hand-held processing device is configured to be able to be operated by battery power.

Expediently, the battery pack can be an electrical rechargeable battery pack.

Expediently, the electrical battery pack is configured for storing electrical energy, on the basis thereof an electrical drive apparatus of the processing device being able to provide drive power for a tool apparatus which can be attached to the processing device.

In one embodiment of the invention, in particular on the basis of at least the third aspect of the invention, the grille element is impermeable to a test specimen which, in particular, has an outer diameter of a minimum of 2 mm and/or a maximum of 50 mm. Quite in particular, the test specimen can have an outer diameter of a minimum of 8 mm and/or a maximum of 20 mm. In particular, the grille openings are impermeable in each case to the test specimen. At least in an opening cross-sectional direction of extent, the opening edge portions defining the respective grille opening can be arranged at a distance from one another which is smaller than the outer diameter of the test specimen. The outer diameter of the test specimen can be present, in particular, on a spherical portion and/or a cylindrical portion of the test specimen. For example, the outer diameter of the test specimen can be 12 mm. In particular, the grille element is only permeable to liquid and dirt particles with a smaller outer diameter.

In a further embodiment of the invention, in particular at least on the basis of the third aspect of the invention, the processing device has a placement apparatus which defines a placement plane, in particular of the processing device or for the processing device. The placement apparatus is configured for contact with a substrate in the placement plane. In particular, the placement apparatus is configured for contact with the substrate in the placement plane when the processing device is intended to be placed or deposited on the substrate. “Placing” and/or “depositing” can be understood synonymously with “positioning”. The placement apparatus can have, for example, support foot portions.

Expediently, the receiving direction runs at an angle to the placement plane. “At an angle” can be at right-angles or at an acute angle. Alternative embodiments in which the receiving direction is oriented parallel to the placement plane can be conceivable.

Particularly expediently, the receiving direction can run obliquely to the placement plane, in particular either inclined to the front or to the rear when viewed in a width direction of the processing device, thus in particular in a side view of the processing device.

Expediently, the grille element terminates flush at least or only in some portions with a bottom surface of a housing of the processing device, in particular on the underside and/or running substantially parallel to the placement plane. The placement apparatus can be shaped integrally with the housing. It is conceivable that only one outer edge portion of the grille element terminates flush with the bottom surface, while another outer edge portion of the grille element, which opposes this outer edge portion terminating flush with the bottom surface, is set back counter to the receiving direction relative to the bottom surface.

Expediently, the grille element can be set back counter to the receiving direction relative to the bottom surface, in particular such that no outer edge portion of the grille element terminates flush with the bottom surface.

Expediently, the housing of the processing device can bear and/or house the electrical drive apparatus of the processing device.

In a further embodiment of the invention, in particular at least on the basis of the third aspect of the invention, the grille element has a grille portion which has at least one grille longitudinal bar. The grille longitudinal bar of the grille portion separates two of the grille openings of the grille element from one another. In particular, the at least one grille longitudinal bar runs at least in a longitudinal direction of extent of the processing device. The longitudinal direction of extent can face from a rear handle of the processing device to a tool attachment apparatus of the processing device, wherein the tool apparatus can be releasably mounted on the tool attachment apparatus. In particular, the longitudinal direction of extent runs parallel to the placement plane and parallel to a longitudinal central plane, wherein the longitudinal central plane is oriented at right-angles to the placement plane.

Expediently, the grille portion of the grille element is a region which, in particular specifically, encompasses all of the grille openings of the grille element.

Expediently, the receiving direction can run at an acute angle to the placement plane, such that it faces obliquely to the rear downwardly counter to the longitudinal direction of extent and/or such that it encloses with the placement plane an acute angle which widens obliquely to the rear downwardly relative to the longitudinal direction of extent. “Rear” can mean “facing away from the tool attachment apparatus”. The acute angle can be 60° to 85°, in particular approximately 80°.

Expediently, the grille portion has two or more grille longitudinal bars which are extended, in particular, substantially parallel to one another.

In a further embodiment of the invention, in particular at least on the basis of the third aspect of the invention, the grille portion of the grille element has a grille transverse bar. The grille transverse bar, in particular, is thickened. In particular, the grille transverse bar can be thickened relative to at least one grille longitudinal bar of the grille portion. The grille transverse bar intersects at least one grille longitudinal bar of the grille element, in particular integrally. The grille transverse bar partially defines at least one of the grille openings of the grille element.

Expediently, the grille transverse bar can have a transverse bar width measured in the longitudinal direction of extent of the processing device. The at least one grille longitudinal bar can have a longitudinal bar width measured in a width direction of the processing device. The width direction runs, in particular, perpendicularly to the longitudinal direction of extent and parallel to the placement plane. The transverse bar width can correspond to 1 to 10 times, in particular 1.5 times to 5 times, more particularly approximately 4 times, the longitudinal bar width.

Expediently, the longitudinal bar width corresponds to 1 to 2 times a wall thickness of the grille element. The wall thickness of the grille element can be a minimum of 1 mm and/or a maximum of 2 mm, for example 1.3 mm.

Expediently, the transverse bar width corresponds to 3 times the wall thickness of the grille element.

Expediently, the grille transverse bar has, in particular, an underside, integral framework structure. In particular, the framework structure can be exposed only toward the placement plane.

Expediently, exactly one grille transverse bar can be present. Alternatively, it is conceivable to provide two or more grille transverse bars.

Expediently, the processing device can have a handle bar which is attached to the housing, in particular so that the handle bar is arranged in the longitudinal direction of extent substantially between the tool attachment apparatus and the receiving apparatus.

Expediently, the grille transverse bar can be part of a force transmission portion of the processing device or partially form the force transmission portion, wherein the force transmission portion adjoins at least one fastening end of the handle bar. The force transmission portion can be configured to be reinforced and/or thickened.

Expediently, integral threaded bores, which are configured in each case for a screw connection of the grille element to the housing, can be provided on the ends of the grille transverse bar opposing one another in the width direction. The threaded bores and/or the screw connections can be a constituent part of the force transmission portion.

In a further embodiment of the invention, in particular at least on the basis of the third aspect of the invention, the grille element has a frame portion. The frame portion, in particular, is free of grille openings. The frame portion encompasses the grille portion of the grille element peripherally. In particular, the frame portion runs directly outside the grille portion enclosed around the grille portion. In particular, the grille portion and the frame portion are shaped integrally with one another.

In particular, the grille transverse bar can extend merely on one side of the grille openings. In other words: the grille transverse bar does not have to be arranged between grille openings but in some embodiments can also be arranged on the edge of the arrangement of grille openings.

In some embodiments-alternatively or additionally to the grille transverse bar-the grille element has, in particular, a thickened grille edge portion, wherein the grille edge portion runs transversely to at least one grille longitudinal bar of the grille element, in particular integrally formed on the grille edge portion and partially defines at least one of the grille openings of the grille element. In particular, the grill edge portion can have, in particular, an underside, integral framework structure.

Expediently, the grille element is configured in one piece.

In a further embodiment of the invention, in particular at least on the basis of the third aspect of the invention, the processing device has electrical connecting elements which are configured for electrically connecting the received battery pack. The connecting elements are borne by the grille element such that the connecting elements face counter to the receiving direction.

Expediently, the connecting elements can be arranged on a tongue portion of the grille element. The tongue portion is, in particular, an integral constituent part of the frame portion of the grille element. The electrical connecting elements can be attached to the tongue portion of the grille element.

Expediently, the tongue portion is flanked by two grille openings of the grille element perpendicular to the receiving direction and/or in the width direction. The tongue portion can be arranged in the width direction between at least two grille openings of the grille element.

In a further embodiment of the invention, in particular at least on the basis of the third aspect of the invention, the grille portion of the grille element protrudes counter to the receiving direction inwardly, in particular into a receiving space of the receiving apparatus. Alternatively or additionally, the grille portion of the grille element can be arranged offset counter to the receiving direction inwardly, in particular into the receiving space of the receiving apparatus. The receiving space is configured, in particular, in a complementary manner to the battery pack. In particular, the grille portion can be set back relative to the underside bottom surface.

Expediently, in some circumstances a contour of the grille element facing counter to the receiving direction can be adapted, in particular, in a complementary manner to the battery pack to be received. Alternatively or additionally, the grille element can form a stop in the receiving direction for the received battery pack.

In a further embodiment of the invention, in particular at least on the basis of the third aspect of the invention—when viewed perpendicularly to the placement plane and/or in the receiving direction—a cumulative surface area of permeable grill opening cross-sectional surfaces of the grille element is a minimum of 10% and/or a maximum of 80% of a surface area of a receiving space cross-sectional surface of the receiving apparatus. The receiving space cross-sectional surface-when viewed in the receiving direction-can correspond to a surface described by a silhouette of the received battery pack and/or a receiving opening cross-sectional surface of the receiving opening. In particular, the cumulative surface area of permeable grille opening cross-sectional surfaces can correspond to 20% to 60%, for example approximately 25%, of the receiving space cross-sectional surface.

Expediently, the processing device can have at least one sliding rib which runs on the underside bottom surface of the processing device. At least one grille longitudinal bar of the grille element can lengthen at least one such sliding rib, in particular in an aligned manner. At least one grille longitudinal bar can fulfill or complement the function of a sliding rib on the underside. It goes without saying that alternatively or additionally at least one grille longitudinal bar can be arranged offset in the width direction to at least one sliding rib.

In a further embodiment of the invention, in particular at least on the basis of the third aspect of the invention, the grille portion of the grille element is extended perpendicularly to the longitudinal direction of extent of the processing device over a grille portion width. The grille portion width is a minimum of 25% and/or a maximum of 75% of a total element width of the grille element measured parallel to the grille portion width. The total element width can be measured on the outside, in particular on the frame portion of the grille element. The grille portion width can be measured on the inside, in particular on the frame portion of the grille element.

In a further embodiment of the invention, in particular at least on the basis of the third aspect of the invention, the grille element comprises a polymer material or consists of such a polymer material. The polymer material can have or be a polyamide (PA). In particular, the polymer material can be PA66-GF30 or PA6 GF15-l.

In a further embodiment of the invention, in particular at least on the basis of the third aspect of the invention, the processing device is configured as a chainsaw, in particular as a motorized chainsaw, or as a blower or as an angle grinder or as hedge trimmers.

Further advantages and features of the invention are found in the claims and in the following description of preferred exemplary embodiments of the invention which are shown by way of the drawings. The same reference signs refer to components which are the same or similar or functionally the same.

It goes without saying that the features mentioned above and to be explained in more detail below can be used not only in the respectively specified combination but also in other combinations or individually without departing from the scope of the present disclosure.

### BRIEF DESCRIPTION OF THE DRAWINGS

FIG. 1 shows in a schematic side view in a stylized manner an embodiment of a hand-held processing device according to the invention;

FIG. 2 shows in a schematic side view a detail of a further embodiment of the processing device according to the invention;

FIG. 3 shows in a schematic rear view a detail of a further embodiment of the processing device according to the invention;

FIG. 4 shows in a schematic side view a detail of a further embodiment of the processing device according to the invention;

FIG. 5 shows in a schematic plan view a detail of a further embodiment of the processing device according to the invention;

FIG. 6 shows in a schematic perspective view a detail of a further embodiment of the processing device according to the invention;

FIG. 7 shows in a further schematic perspective view a detail of a further embodiment of the processing device according to the invention;

FIG. 8 shows in a schematic perspective view a further embodiment of the processing device according to the invention;

FIG. 9 shows in a schematic perspective view a detail of a further embodiment of the hand-held processing device according to the invention;

FIG. 10 shows in a schematic sectional view a detail of a further embodiment of the hand-held processing device according to the invention;

FIG. 11 shows in a schematic bottom view a detail of a further embodiment of the processing device according to the invention;

FIG. 12 shows in a schematic plan view a detail of a further embodiment of the hand-held processing device according to the invention;

FIG. 13 shows in a schematic perspective view a grille element for a further embodiment of the processing device according to the invention;

FIG. 14 shows in a further schematic perspective view the grille element according to FIG. 13;

FIG. 15 shows in a perspective detailed view a further embodiment of the processing device according to the invention; and

FIG. 16 shows in a further perspective detailed view in section the processing device according to FIG. 15.

### DETAILED DESCRIPTION OF THE DRAWINGS

A hand-held processing device 100 has a receiving apparatus 49. The receiving apparatus 49 is configured for replaceably coupling an electrical battery pack 200 in a receiving direction 60. The term “couple” can be understood synonymously with the term “receive”. The coupled or received battery pack 200 can be removed again from the receiving apparatus 49 counter to the receiving direction 60. The battery pack 200 can be an electrical rechargeable battery pack.

The receiving apparatus 49 has a receiving space 74 for the battery pack 200. The receiving space 74 can correspond to a compartment interior of a battery compartment of the receiving apparatus 49.

The processing device 100 in the present case is longitudinally extended in a longitudinal direction of extent 11. A width direction 81 of the processing device 1000 runs in the present case perpendicularly to the receiving direction 60 and perpendicularly to the longitudinal direction of extent 11.

The receiving apparatus 49 has in the present case a receiving opening 61 which is configured for introducing the battery pack 200 to be received. Depending on the length of the battery pack 200, the battery pack 200 in its received state can protrude through the receiving opening 61 or be arranged substantially fully in the receiving space 74.

The processing device 100 has, for example, an electrical drive apparatus which is configured for providing drive power based on the electrical energy taken from received battery pack 200. The processing device 100 has, for example, a tool attachment apparatus on which a tool apparatus can be mounted. Drive power can be provided for the tool apparatus by means of the electrical drive apparatus.

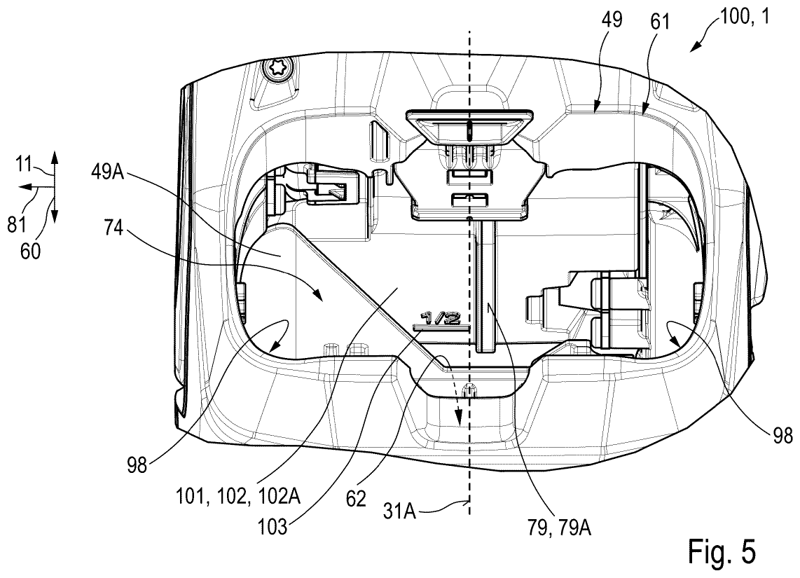

The processing device 100 has in the present case a lubricant tank 101 which serves for storing lubricant, in particular for the tool apparatus. The processing device 100 has in the present case a filling level display apparatus 102A which is configured for displaying a filling level of lubricant stored in the lubricant tank 101. The filling level display apparatus 102A is arranged in the present case such that the displayed filling level can be read from the outside by looking through the receiving opening 61 when the battery pack 200 is not received, see in particular the view of FIG. 5.

The processing device 100 can have at least one viewing opening 80 which opens the receiving space 74 outwardly and through which the filling level displayed by means of the display apparatus 102A can be read by looking through from the outside when the battery pack 200 is not received.

The receiving apparatus 49 of the processing device 100 has a front receiving apparatus side 79A relative to the longitudinal direction of extent 11. The front receiving apparatus side 79A can form a front guide surface portion 79 for guiding the battery pack 200 in the receiving direction 60 or can run parallel to the front guide surface portion 79. The front receiving apparatus side 79A defines the receiving space 74, in particular, perpendicularly to the receiving direction 60 and/or in the longitudinal direction of extent 11.

The processing device 100 in the present case has two viewing openings 80. Exactly two viewing openings 80 can be present- or optionally more than two viewing openings 80. The two viewing openings 80 are arranged opposing the front receiving apparatus side 79A. The viewing openings 80 open the receiving space 74 in each case outwardly counter to the longitudinal direction of extent 11.

By means of the viewing openings 80 the receiving space 74 can communicate fluidically with an external environment of the processing device 100 counter to the longitudinal direction of extent 11. Under some circumstances, it can be alternatively conceivable to close the viewing openings 80 by means of a transparent panel which is impermeable to fluid but nevertheless transparent.

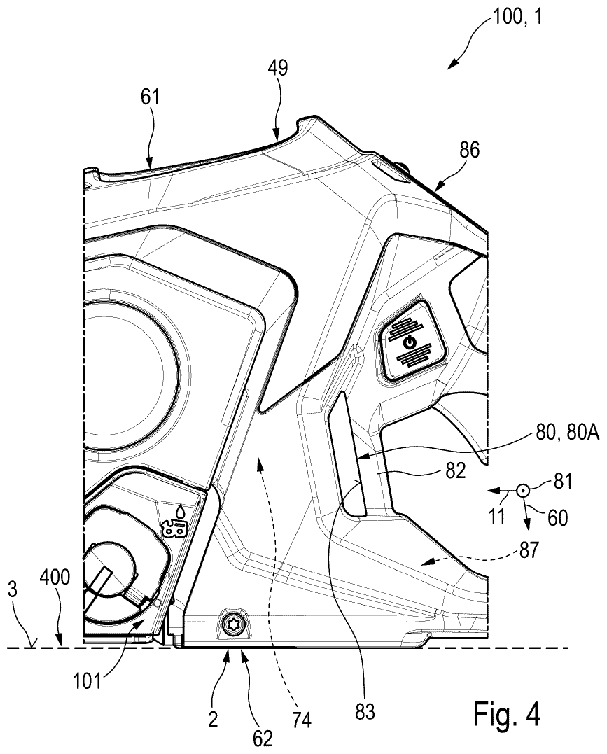

The two viewing openings 80 are arranged in the present case relative to one another such that they are aligned with one another in a transparent manner-when the battery pack 200 is not received-when viewed in the width direction 81, see in particular the views of FIGS. 2 and 4.

A label, which can be read through at least one of the viewing openings 80 in a received state of the battery pack 200, can be present on the battery pack 200.

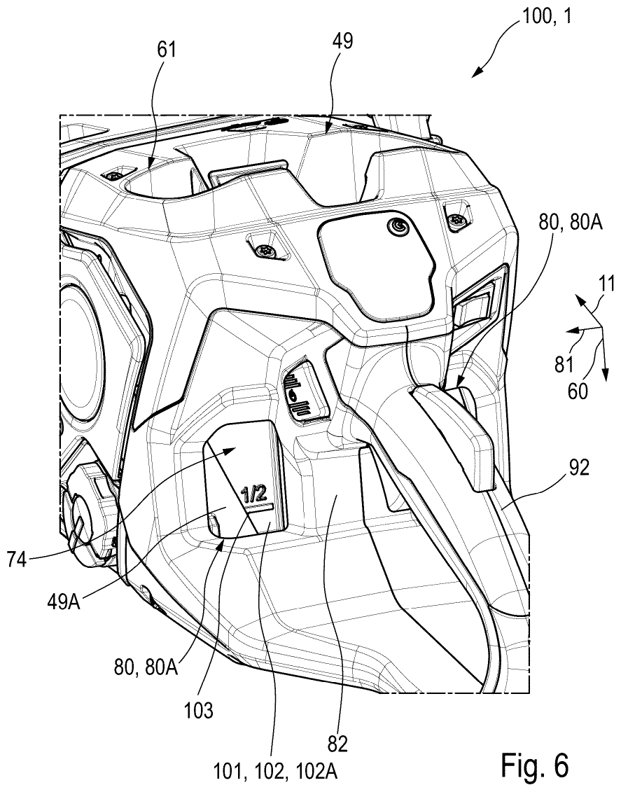

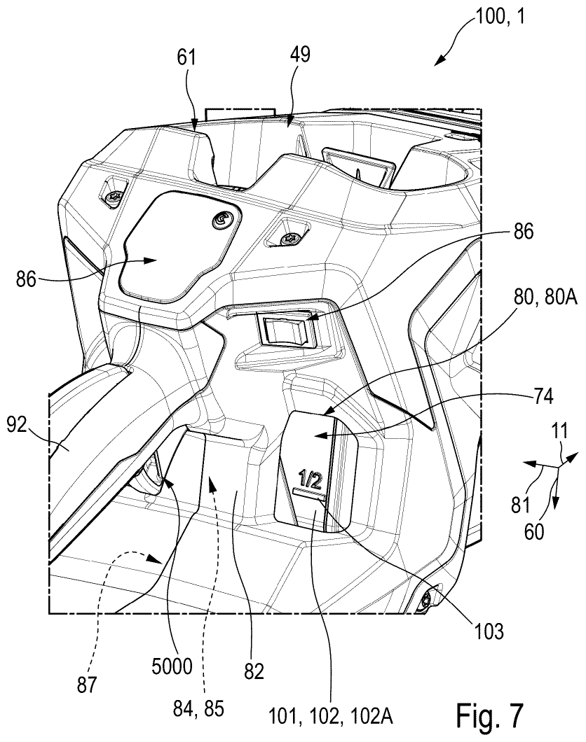

In the present case, the filling level display apparatus 102A is arranged such that the displayed filling level can be read from the outside respectively by looking through one of the two viewing openings 80 when the battery pack 200 is not received, see in particular the view of FIGS. 6 and 7. The filling level display apparatus 102A can at least partially form the front receiving apparatus side 79A-as in the present case.

For example, the lubricant tank 101 has at least one transparent tank wall portion 102. For example, the transparent tank wall portion 102 at least partially forms the filling level display apparatus 102A. A level of lubricant present in the interior of the lubricant tank 101 can be shown on the outside on the transparent wall portion 102, in order to be able to be read on the outside of the lubricant tank 101 through the receiving opening 61 and/or through the viewing openings 80.

The processing device 100 has, for example, a placement apparatus 2 which defines a placement plane 3, in particular of the processing device 100. The placement apparatus 2 is configured for contact with a substrate 400 on which the processing device 100 can be placed in the placement plane 3. If the processing device 100 is placed on the substrate 400, contact points between the placement apparatus 2 and the substrate 400 could be located in the placement plane 3.

The receiving direction 60 in the present case runs at an angle, for example at right-angles, or -as in the present case-at an acute angle to the placement plane 3. In an alternative embodiment, the receiving direction 60 can also run parallel to the placement plane 3, for example in the width direction 81.

The receiving opening 61 opposes the placement apparatus 2 of the processing device 100, in the present case in the receiving direction 60. Alternatively or additionally-as in the present case-the filling level display apparatus 102A can be inclined relative to the placement plane 3, for example for optimization of a reading viewing angle.

The filling level display apparatus 102A in the present case has a marking 103 as a reference indicator for the filling level. The marking 103 is visible from the outside by looking through the receiving opening 61 and/or through the viewing openings 80 when the battery pack 200 is not received. In particular, a plurality of markings 103 can also be provided as a reference indicator for the filling level of the lubricant tank 101, in particular for at least one or more filling level values.

The receiving apparatus 49 has, for example, a wall portion 49A. The wall portion 49A can partially conceal the lubricant tank 101, in particular the transparent tank wall portion 102 of the lubricant tank 101. For example, the wall portion 49A runs substantially in a plane spanned by the receiving direction 60 and by the width direction 81, wherein the wall portion 49 has an upper edge which runs in the plane and which runs at an acute angle relative to the width direction 81. The wall portion 49 can be opaque.

In the present case, a web portion 82 of the processing device 100 runs between the viewing openings 80 relative to the width direction 81. The web portion 82 can be longitudinally extended continuously in the receiving direction 60. The viewing openings 80 in the present case flank the web portion 82 relative to the width direction 81.

In the present case, the web portion 82 at least partially forms a rear guide surface portion 83 of the processing device 100 relative to the longitudinal direction of extent 11 for guiding the battery pack 200 in the receiving direction 60.

For example, the web portion 82 has a line channel 84 for guiding at least one electrical line 85. In the present case, electrical lines 85 are guided through the line channel 84.

The processing device 100 has, for example, an operating apparatus 86 which can be operated by a user. In addition, in the present case the processing device 100 has an electronic control apparatus 87 which is connected by means of the electrical lines 85 to the operating apparatus 86 in the receiving direction 60.

The processing device 100 can have a further, in particular electronic, control unit 91, in particular additionally to the control apparatus 87. For example, the control unit 91 can have a main control unit of the processing device 100 for controlling the drive apparatus. The control unit 91 can be arranged in the longitudinal direction of extent 11 between the drive apparatus and an end of the processing device 100 facing the tool. The control apparatus 87 can be subordinate to the control unit 91. For example, the control apparatus 87 can be supplied with electrical voltage by means of the control unit 91, in particular in a controlled manner. The control apparatus 87 can serve for controlling an additional functional apparatus, such as for example a handle heater of the processing device 100.

The web portion 82 has, for example, a web width 88 measured parallel to the width direction 81. The receiving space 74 has, for example, in particular an inner receiving space width 89 measured parallel to the width direction 81. The receiving space width 89 can correspond to 1.5 times to 6 times the web width 88. In the present case, the receiving space width 89 corresponds approximately to 3 times the web width 88.

The receiving space 74 has in the present case an end facing the placement plane 3, in particular a front end. The control apparatus 87-as in the present case-can adjoin the receiving apparatus 49 in the region of this end of the receiving space 74 counter to the longitudinal direction of extent 11. The control apparatus 87 can thus adjoin the receiving apparatus 49 in the region of the end of the receiving space 74 facing the placement plane 3 to the rear relative to the longitudinal direction of extent 11.

As can be identified, in particular, in the views of FIGS. 2, 3, 4, 6 and 7, a housing of the processing device 100 can have an external depression which adjoins the receiving apparatus 49 in the region of the end of the receiving space 74 facing the placement plane 3 counter to the longitudinal direction of extent 11. A cavity, within which the control apparatus 87 is arranged, can be present in the interior of this depression. The control apparatus 87 arranged therein can serve, in particular, for controlling a handle heater for a rear handle portion 92 of the processing device 100. Alternatively or additionally, the processing device 100 can have at least one further control apparatus 87. If the processing device 100 is implemented without a handle heater, the cavity which is present in the interior of the depression can optionally remain empty.

In the present case, the rear handle portion 92 defines a rear end 94 of the processing device 100, in particular facing away from the tool relative to the longitudinal direction of extent 11. A longitudinal central plane 31A of the processing device 100 is defined in the present case by the rear handle portion 92.

The processing device 100 has, for example, electrical connecting elements 72 for electrically connecting the received battery pack 200. The electrical connecting elements 72 can be arranged in the receiving direction 60 between the viewing openings 80 and the placement apparatus 2 of the processing device 100. In the present case, the electrical connecting elements 72 face counter to the receiving direction 60 and/or to the receiving opening 61.

The receiving apparatus 49 has, for example, a through-opening 62 which is, in particular, provided with a grille and/or is on the bottom side, opposing the receiving opening 61 in the receiving direction 60.

In the present case, the viewing openings 80 are configured and/or arranged mirror-symmetrically relative to the longitudinal central plane 31A. In the present case, the viewing openings 80 are configured as a mirror-symmetrical pair of openings relative to the longitudinal central plane 31A.

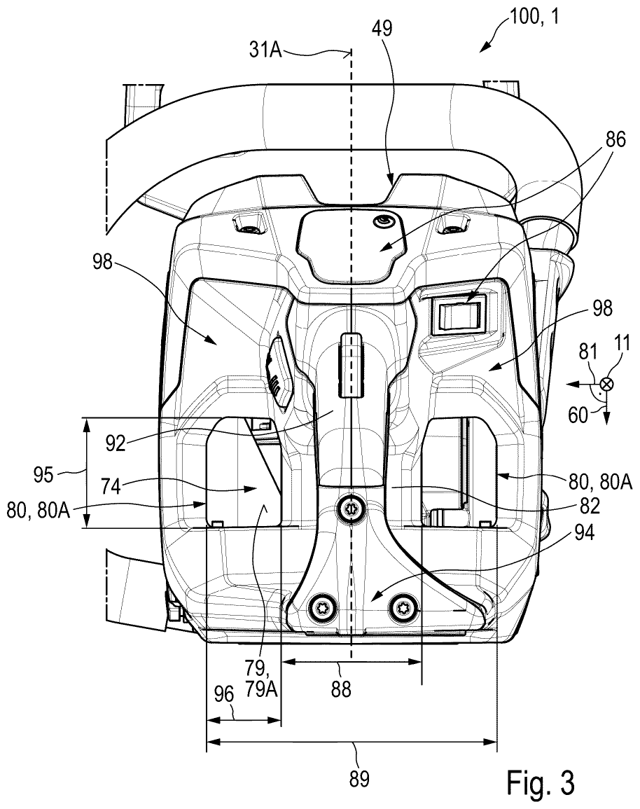

The viewing openings 80 are longitudinally extended, for example, in the receiving direction 60. An opening length 95 of the viewing openings 80 measured in the receiving direction 60 can be in each case 10 mm to 120 mm, for example in each case between 30 mm and 50 mm, as in the present case. Alternatively or additionally, an opening width 96 of the viewing openings 80 measured perpendicularly to the receiving direction 60, in particular in a rear view of the processing device 100 resulting from viewing in the longitudinal direction of extent 11, can be in each case 10 mm to 50 mm, see in particular the view of FIG. 3.

The, in particular hollow, receiving space 74 can have a substantially prismatic, for example in the present case cuboidal, shape. In the present case, the in particular negative shape of the receiving space 74 has at least two edge regions 89 longitudinally extended in the receiving direction 60. The edge regions 89 flank the rear guide surface portion 83 which partially defines the receiving space 74 in the width direction 81. In the present case, the rear guide surface portion 83 is thus between the two, in particular inner, edge regions 89 relative to the width direction 81.

For example, in each case one of the viewing openings 80 interrupts one of the edge regions 89. Respectively one of the edge regions 89 can be longitudinally extended by 1.5 times to 15 times the opening length 95 of the viewing openings 80.

In the view of FIG. 2, by way of example an imaginary straight line VT is illustrated at right-angles to the placement plane 3. Corresponding to the view of FIG. 2 the straight line VT—when viewed in the width direction 81—is at a tangent to the opening edges 80A of the viewing openings 80 in each case relative to the longitudinal direction of extent 11 at the front. The straight line VT—as in the present case-can run in front of the electrical connecting elements 72 relative to the longitudinal direction of extent 11 of the processing device 100. Alternatively, it is conceivable that the straight line VT intersects the connecting elements 72. The electrical connecting elements 72 can be located in a bottom region of the receiving apparatus, in particular as far as the bottom region of the receiving apparatus which is configured as a battery compartment. For example, the connecting elements 72 are located on the side of the battery compartment facing away from the tool apparatus.

The processing device 100 is configured in the present case as a chainsaw 1, in particular as a motorized chainsaw. The tool apparatus for the chainsaw 1 can be—as in the present case—a saw chain guide bar 50 for peripheral guidance of a saw chain 51. In its mounted state, the saw chain guide bar 50 can be longitudinally extended substantially in the longitudinal direction of extent 11 and/or parallel to the longitudinal central plane 31A.

The processing device 100 can have a brake lever 13, at least one movable part of the tool apparatus being able to be braked by the actuation thereof. In the present case, the saw chain 51 can be braked, in particular stopped, by an actuation of the brake lever 13.

The processing device 100 can have an actuating lever 5000, in particular a gas lever, for activating the drive apparatus, in particular in the form of an electric motor, quite in particular in the form of a brushless electric motor.

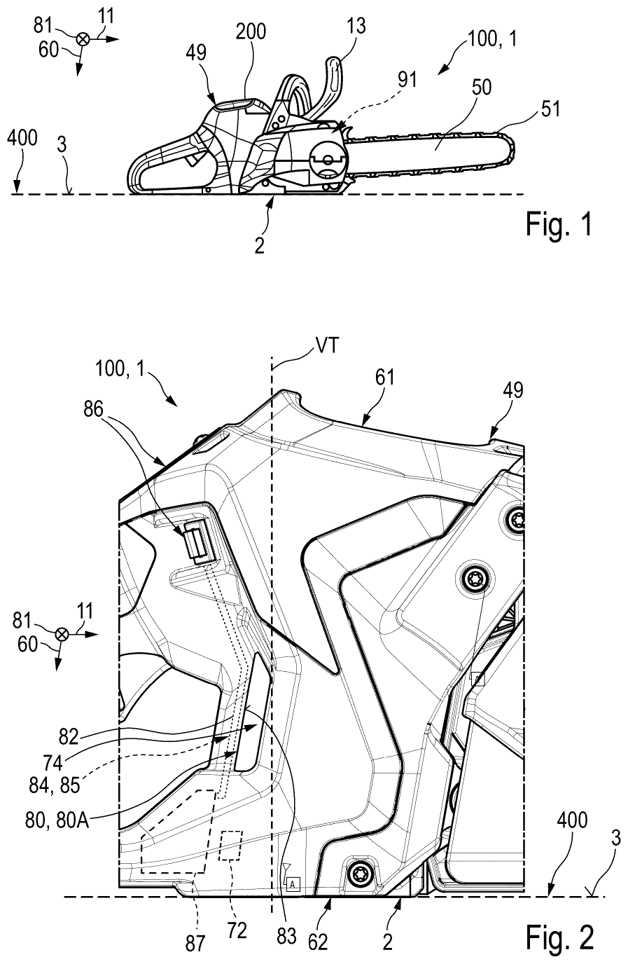

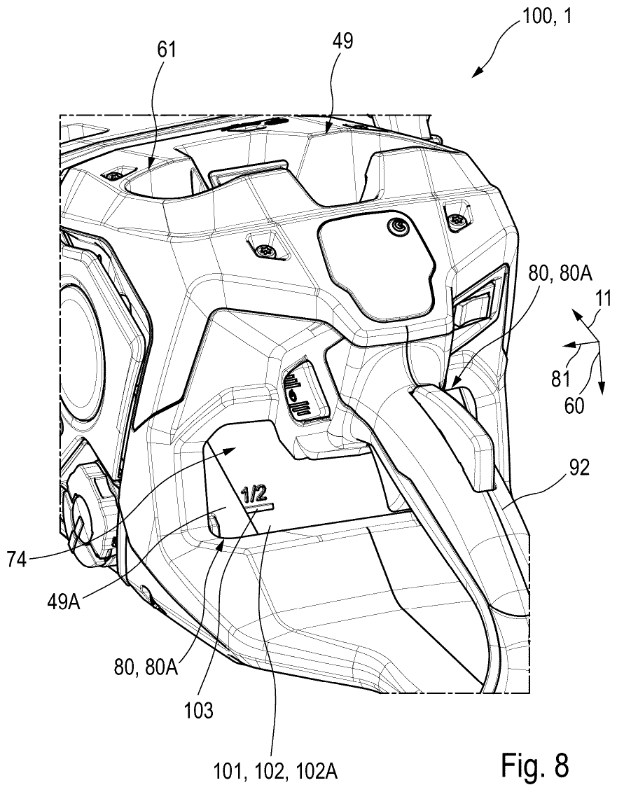

The views of FIGS. 1 to 8 can refer to the same embodiment of the hand-held processing device 100. In particular, the details shown can be those of a single processing device 100.

The processing device 100 can be configured in other embodiments as an angle grinder, brush cutter, blower or as hedge trimmers.

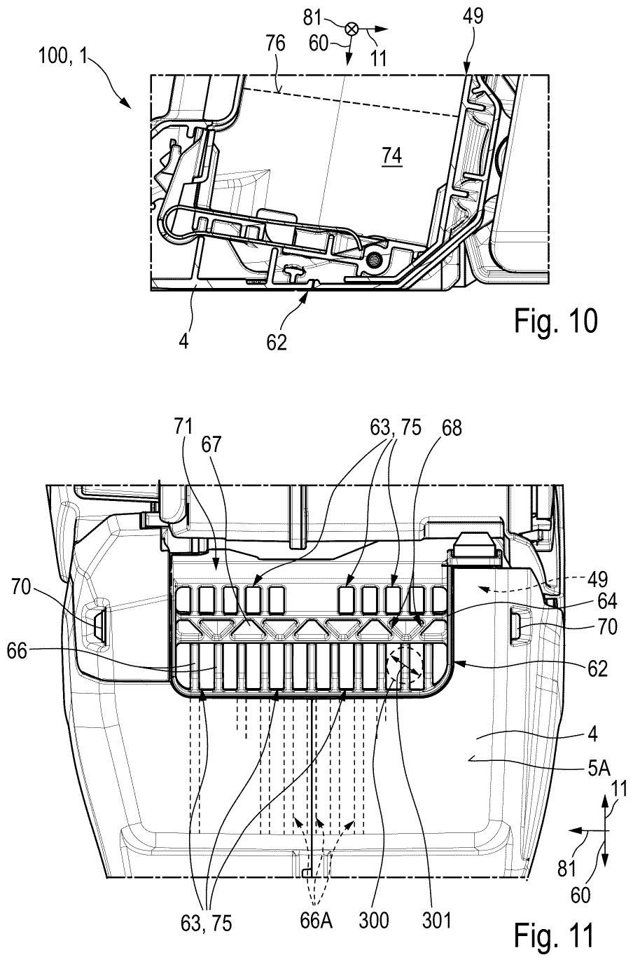

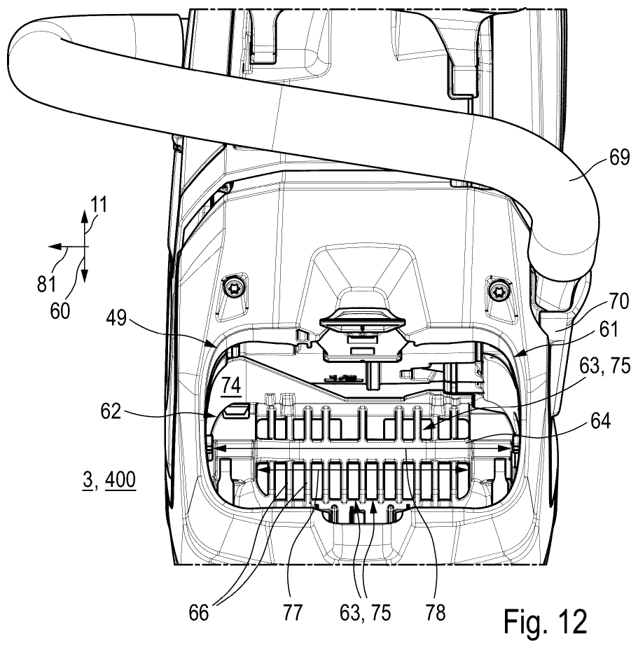

Further exemplary embodiments are explained hereinafter, in particular with reference to FIGS. 1 and 9 to 14. Some of the above contents of the description for the exemplary embodiments are repeated again, in particular if they are also important for the understanding of the examples of FIGS. 1 and 9 to 14. The hand-held processing device 100 has a receiving apparatus 49. The receiving apparatus 49 is configured for replaceably receiving an electrical battery pack 200. The receiving apparatus 49 is configured to receive the battery pack 200 in a receiving direction 60. The battery pack 200 to be received can be removed again from the receiving apparatus 49 counter to the receiving direction 60.

The receiving apparatus 49 has a receiving opening 61 which is configured for introducing the battery pack 200 to be received. In particular, the battery pack 200 can be introduced through the receiving opening 61 into a receiving space 74 of the receiving apparatus 49. In the received state of the battery pack 200, the receiving space 74 can be substantially filled by a plug-in portion of the battery pack 200. It goes without saying that in the present case the receiving opening 61 also serves for taking out the received battery pack 200 again.

The receiving space 74 can have a substantially prismatic, in particular substantially cuboidal, shape. The battery pack 200 can have, in particular at least in its plug-in portion, an external shape which is configured in a substantially complementary manner to the shape of the receiving space 74.

The receiving apparatus 49 has a through-opening 62, in particular on an underside, for expelling dirt. The through-opening 62 is located opposite the receiving opening 61. For example, the through-opening 62 opposes the receiving opening 61 in the receiving direction 60.

The processing device 100 has a grille element 64 which has at least three, in the present case more than three, grille openings 63. The grille element 64 is configured and arranged in the present case for providing the through-opening 62 with a grille which is permeable to dirt.

For example, the grille element 64 is impermeable to a test specimen 300. For example, the grille element 64 is impermeable to a test specimen 300 having an outer diameter 301 of 2 mm to 50 mm, in particular a minimum of 8 mm and/or a maximum of 20 mm. In the present case, the grille element 64 is impermeable to a test specimen 300 having an outer diameter 301 of 12 mm. The grille openings 63 can be narrowed such that the test specimen 300 can pass through none of the grille openings 63, in particular in the receiving direction 60. The permeability of the grille element 64 can be described and/or specified on the basis of the outer diameter 301 of the test specimen 300, in particular similar to an opening or mesh size.

The processing device 100 has in the present case a placement apparatus 2. The placement apparatus 2 can have support feet and/or support ribs. The placement apparatus 2 defines a placement plane 3. The placement apparatus 2 is configured for contact with a substrate 400 in the placement plane 3. In particular, the placement apparatus 2 contacts the substrate 400 when the processing device 100 is placed on the substrate 400.

In the present case, the receiving direction 60 runs at an angle to the placement plane 3. The receiving direction 60 can run at right-angles or -as in the present case-at an acute angle to the placement plane 3. In the present case, the receiving direction 60 and the placement plane 3 enclose an acute angle which widens to the rear downwardly counter to a longitudinal direction of extent 11 of the processing device 100. In this regard, the battery pack 200 can be received by the receiving apparatus 49 from the front at the top.

The grille element 64 has, for example, a grille portion 65. The grille portion 65 has, for example, at least one grille longitudinal bar 66 which runs in the present case in the longitudinal direction of extent 11 of the processing device 100. The at least one grille longitudinal bar 66 separates two of the grille openings 63 of the grille element 64 from one another. In the present case, a plurality of grille longitudinal bars 66 extending substantially parallel to one another are present.

The grille portion 65 of the grille element 64 has in the present case a grille transverse bar 67. The grille transverse bar 67 intersects the at least one grille longitudinal bar 66, in the present case all of the grille longitudinal bars 66 of the grille element 64. In the present case, the grille longitudinal bars 66 and the grille transverse bar 67 are connected integrally to one another at their points of intersection. The grille transverse bar 67 partially defines at least one of the grille openings 63, in the present case a plurality of grille openings 63, of the grille element 64. The grille transverse bar 67 can be configured to be thickened, as in the present case, relative to the grille longitudinal bars 66.

The processing device 100 has a width direction 81 which runs perpendicularly to the longitudinal direction of extent 11 and parallel to the placement plane 3. In the present case, the grille transverse bar 67 is longitudinally extended in the width direction 81.

For example, the grille transverse bar 67 has an integral framework structure 68. In the present case, the framework structure 68 is configured on the underside. The framework structure 68 can be covered integrally toward the receiving space 74.

In the present case, the grille element 64 has a frame portion 71. The frame portion 71 is configured, for example, without grille openings 63. The frame portion 71 borders the grille portion 65 of the grille element 64. In the present case, the grille portion 64 and the frame portion 71 are configured integrally. The grille element 64 can be configured in one piece.

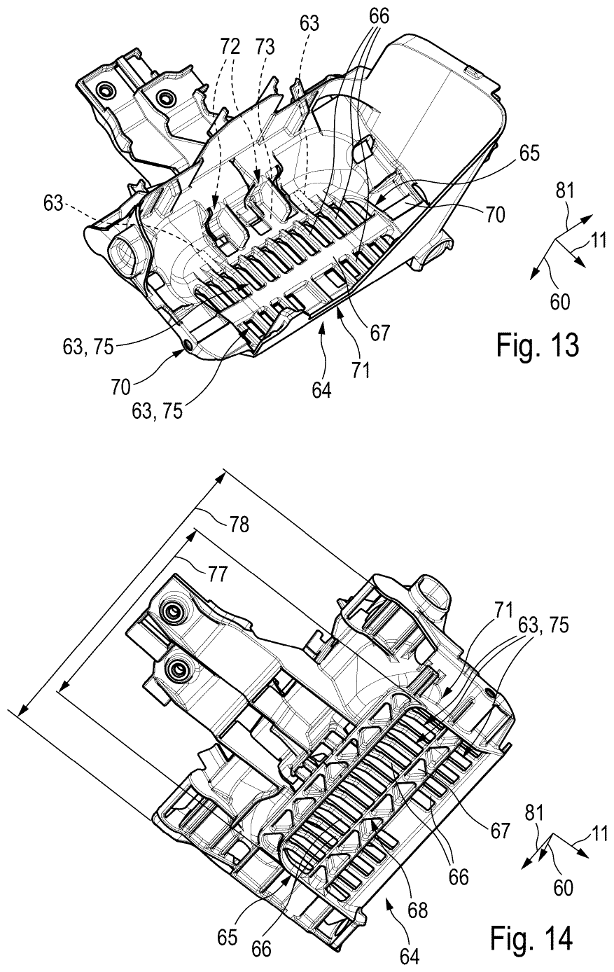

The processing device 100 has, for example, electrical connecting elements 72 which are configured for electrically connecting the received battery pack 200. In the present case, the grille element 64 bears the connecting elements 72 such that the connecting elements 72 face counter to the receiving direction 60 and/or the receiving opening 61. In the view of FIG. 13, the position of the connecting elements 72 is illustrated by way of example.

The grille element 64 has, for example, a tongue portion 73, wherein the connecting elements 72 are attached to the tongue portion 73. In the present case, the tongue portion 73 is part of the frame portion 71 of the grille element 64, in particular in an integral manner. The tongue portion 73 is flanked, for example, perpendicularly to the receiving direction 60 and/or in the width direction 81 by two of the grille openings 63 of the grille element 64, as is indicated in dashed lines in the view of FIG. 13.

The grille element 64 can terminate at least or—as in the present case—only in some regions flush with a bottom surface 5A of a housing 4 of the processing device 100 running on the underside and/or running substantially parallel to the placement plane 3. Alternatively or additionally, the grille portion 65 of the grille element 64 can be arranged offset inwardly to the receiving space 74 counter to the receiving direction 60.

The grille portion 65 of the grille element 64 can protrude counter to the receiving direction 60 inwardly into the receiving space 74 of the receiving apparatus 49.

The grille openings 63 of the grille element 64 have in the present case—when viewed perpendicularly to the placement plane 3—a grille opening cross-sectional surface 75 in each case. When viewed in the receiving direction 60, the receiving space 74 has a receiving space cross-sectional surface 76. In the present case, permeable grille cross-sectional opening surfaces 75 together define a cumulative surface area which, for example, is at least 10% and/or a maximum of 80% of a surface area of the receiving space cross-sectional surface 76.

In particular, integral sliding ribs 66A can run on the underside bottom surface 5A of the processing device 100. The sliding ribs 66A can be longitudinally extended in the longitudinal direction of extent 11. At least one grille longitudinal bar 66 of the grille element 64 can lengthen at least one of the sliding ribs 66A, in particular in an aligned manner.

In the present case, the grille portion 65 of the grille element 64 is extended perpendicularly to the longitudinal direction of extent 11 of the processing device 100 over a grille portion width 77. In particular, the grille portion 65 is extended in the width direction 81 of the processing device 100 over the grille portion width 77. The grille element 64 is extended in the present case over a total element width 78, wherein the total element width 78 can be measured parallel to the grille portion width 77. The grille portion width 77 is, for example, at least 25% to a maximum of 75% of the total element width 78. In the present case, the total element width 78 corresponds to an extent of the grille element 64 in the width direction 81 including the frame portion 71, while the grille portion width 77 corresponds only to an extent of the grille portion 65 not including the frame portion 71.

The frame portion 71 can clad an inner surface of the through-opening 62, in particular in the manner of a frame.

The grille element 64 comprises, for example, a polymer material or consists of a polymer material. The polymer material can be PA66-GF30. For example, the grille element 64 does not consist of wood.

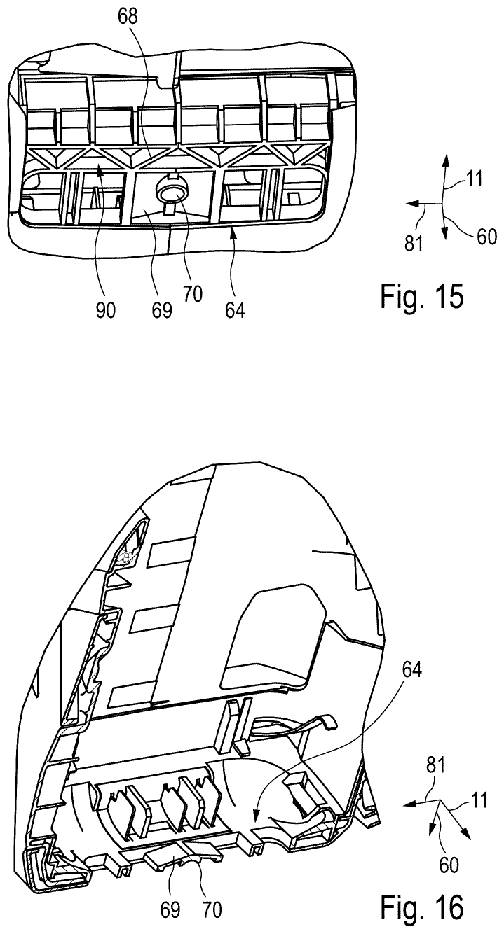

As can be identified, in particular, by way of the views of FIGS. 15 and 16, the grille element 64 can have a connecting web 69 which is centrally arranged, in particular, in terms of strength and/or relative to the width direction 81. The connecting web 69 can have, for example, at least one oblique surface running obliquely in the width direction 81, in particular dropping obliquely outwardly when viewed in the receiving direction 60. The oblique surface can promote an expulsion of dirt in the receiving direction 60.

In the example of FIGS. 15 and 16, the connecting web 69 is configured with two oblique surfaces which are oriented away from one another and run obliquely outwardly and which are arranged in the manner of the roof surfaces of a pitched roof. It goes without saying that optionally more than one such connecting web 69 can be provided. A material casting point 70, in particular an injection point, of the grille element 64 can be arranged on a side of the connecting web 69 opposing the oblique surfaces in the receiving direction 60.

In the example of FIGS. 15 and 16, in particular, a V-shaped cavity of the connecting web 69 opposing the oblique surfaces is located in the receiving direction 60, the material casting point 70 being arranged set back therein relative to the bottom surface 5A of the processing device 100.

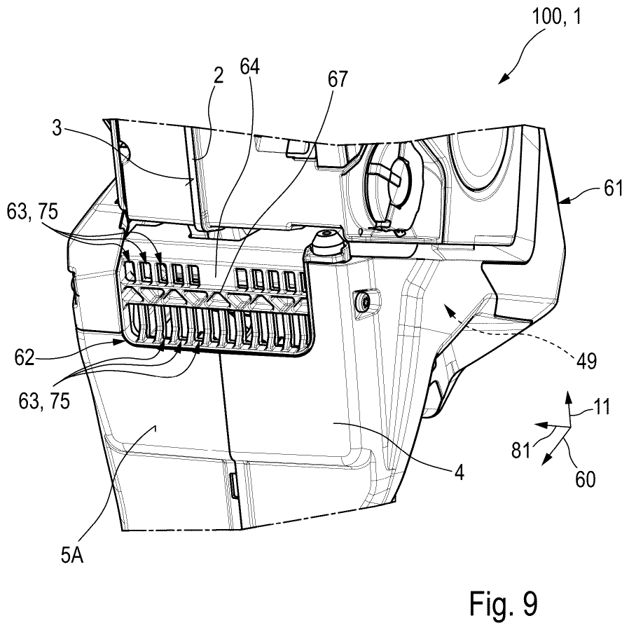

The views of FIGS. 15 and 16 also make it possible to identify that the grille element 64, in contrast to the examples of FIGS. 9 to 14, can be configured without a grille transverse bar 67. The variant of FIGS. 15 and 16 shows a grille edge portion 90 of the grille element 67 which is longitudinally extended in the width direction 81 and which partially defines at least one of the grille openings 63, in the present case a plurality of grille openings 63 of the grille element 64. The grille edge portion 90 forms, in particular, a region of the frame portion 71. The grille edge portion 90 can be configured—as in the present case—to be thickened relative to the grille longitudinal bars 66.

The grille edge portion 90 in the example of FIGS. 15 and 16 functionally replaces the grille transverse bar 67 of FIGS. 9 to 14. For example, the grille edge portion 90 has an integral framework structure 68. In the present case, the framework structure 68 of the grille edge portion 90 is configured on the underside. The framework structure 68 of the grille edge portion 90 can be covered integrally toward the receiving space 74.

It goes without saying that in the various embodiments the grille edge portion 90 can be present alternatively or additionally to the grille transverse bar 67.

The processing device 100 is configured in the present case as a chainsaw 1, in particular as a motorized chainsaw. The tool apparatus for the chainsaw 1 can be—as in the present case—a saw chain guide bar 50 for peripheral guidance of a saw chain 51.

The processing device 100 can have a brake lever 13, at least one movable part of the tool apparatus being able to be braked by the actuation thereof. In the present case, the saw chain 51 can be braked, in particular can be stopped, by an actuation of the brake lever 13.

The views of FIGS. 1 and 9 to 16, in particular also those of FIGS. 2 to 8, can refer to the same embodiment of the hand-held processing device 100. In particular, the details shown can be those of a single processing device 100.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A hand-held processing device, comprising:
a receiving apparatus for replaceably receiving an electrical battery pack in a receiving direction, wherein the receiving apparatus has a receiving space for the battery pack;
a front receiving apparatus side relative to a longitudinal direction of extent of the processing device, wherein the front receiving apparatus side partially defines the receiving space; and
at least two viewing openings which oppose the front receiving apparatus side and which in each case open the receiving space outwardly counter to the longitudinal direction of extent,
wherein the at least two viewing openings are arranged relative to one another such that they are aligned with one another in a transparent manner, when the battery pack is not received, when viewed in a width direction of the processing device at right-angles both to the receiving direction and to the longitudinal direction of extent.

2. The hand-held processing device according to claim 1,
wherein the at least two viewing openings in the width direction flank a web portion of the processing device which is continuous in the receiving direction,
wherein the web portion at least partially forms a rear guide surface portion of the processing device relative to the longitudinal direction of extent for guiding the battery pack in the receiving direction.

3. The hand-held processing device according to claim 2,
wherein the web portion has a line channel of the processing device for guiding at least one electrical line which connects an operating apparatus of the processing device to an electronic control apparatus.

4. The hand-held processing device according to claim 2,
wherein the web portion has a web width measured in the width direction,
wherein the receiving space has a receiving space width measured in the width direction, and
wherein the receiving space width corresponds to 1.5 times to 6 times the web width.

5. The hand-held processing device according to claim 1,
wherein the processing device has a placement apparatus which defines a placement plane and which is configured for contact with a substrate in the placement plane, and
wherein the receiving direction runs at an angle to the placement plane.

6. The hand-held processing device according to claim 5,
wherein an electronic control apparatus of the processing device adjoins the receiving apparatus in the region of an end of the receiving space facing the placement plane counter to the longitudinal direction of extent.

7. The hand-held processing device according to claim 1,
wherein electrical connecting elements of the processing device, which face counter to the receiving direction, are present in the receiving direction between the viewing openings and a placement apparatus of the processing device; and/or
wherein the receiving apparatus has a receiving opening for introducing the battery pack to be received and a through-opening which opposes the receiving opening in the receiving direction and which is provided with a grille.

8. The hand-held processing device according to claim 1,
wherein the at least two viewing openings are configured mirror-symmetrically relative to a longitudinal central plane of the processing device.

9. The hand-held processing device according to claim 1,
wherein the at least two viewing openings are longitudinally extended in the receiving direction,
wherein an opening length of the at least two viewing openings measured in the receiving direction is in each case 10 mm to 120 mm, and/or an opening width of the viewing openings measured perpendicularly to the receiving direction is in each case 10 mm to 50 mm.

10. The hand-held processing device according to claim 1,
wherein the receiving space has a substantially prismatic shape,
wherein the shape of the receiving space has at least two edge regions which are longitudinally extended in the receiving direction and which flank a rear guide surface portion of the processing device partially defining the receiving space in the width direction,
wherein each of the at least two viewing openings interrupts one of the edge regions,
wherein respectively one of the edge regions is longitudinally extended by 1.5 times to 15 times an opening length of the viewing openings.

11. The hand-held processing device according to claim 1,
wherein the processing device is a chainsaw or an angle grinder.

12. The hand-held processing device according to claim 1, wherein, when viewed in the width direction, an imaginary straight line at right-angles to a placement plane is at a tangent to the opening edges of the at least two viewing openings relative to the longitudinal direction of extent of the processing device at the front, such that the straight line runs relative to the longitudinal direction of extent of the processing device in front of or through electrical connecting elements of the processing device for the battery pack.

13. A hand-held processing device, comprising:
a receiving apparatus for replaceably receiving an electrical battery pack in a receiving direction, wherein the receiving apparatus has a receiving opening for introducing the battery pack to be received;
a lubricant tank for storing lubricant; and
a filling level display apparatus for displaying a filling level of stored lubricant,
wherein the filling level display apparatus is arranged such that the displayed filling level is readable from outside by looking through the receiving opening for the battery pack when the battery pack is not received.

14. The hand-held processing device according to claim 13,
wherein the lubricant tank has at least one transparent tank wall portion, and
wherein the at least one transparent tank wall portion forms the filling level display apparatus.

15. The hand-held processing device according to claim 13,
wherein the filling level display apparatus has a marking as a reference indicator for the filling level which is visible from the outside by looking through the receiving opening when the battery pack is not received.

16. The hand-held processing device according to claim 13,
wherein the processing device has at least one viewing opening which opens outwardly a receiving space of the receiving apparatus,
wherein the filling level display apparatus is arranged such that the displayed filling level is readable from the outside by looking through the viewing opening when the battery pack is not received.

17. A hand-held processing device, comprising:
a receiving apparatus for replaceably receiving an electrical battery pack in a receiving direction, wherein the receiving apparatus has a receiving opening for introducing the battery pack to be received and a through-opening opposing the receiving opening for expelling dirt; and
a grille element having at least three grille openings for providing the through-opening with a grille which is permeable to dirt.

18. The hand-held processing device according to claim 17,
wherein the grille element is impermeable to a test specimen which has an outer diameter of 2 mm to 50 mm.

19. The hand-held processing device according to claim 17,
wherein the grille element bears electrical connecting elements of the processing device, which face counter to the receiving direction and which are configured for electrically connecting the received battery pack,
wherein the electrical connecting elements are attached to a tongue portion of the grille element, and the tongue portion is flanked by two of the grille openings of the grille element perpendicular to the receiving direction.

20. The hand-held processing device according to claim 17,
wherein a grille portion of the grille element has a thickened grille transverse bar, wherein the grille transverse bar intersects at least one grille longitudinal bar of the grille element and partially defines at least one of the grille openings of the grille element, wherein the grille transverse bar has an underside, integral framework structure; and/or
wherein the grille element has a thickened grille edge portion, wherein the grille edge portion runs transversely to at least one grille longitudinal bar of the grille element and partially defines at least one of the grille openings of the grille element, wherein the grille edge portion has an underside, integral framework structure.
